(19) United States
(12) Patent Application Publication
(10) Pub. No.: US 2017/0298679 A1
(43) Pub. Date: Oct. 19, 2017

(54) Vacuum Insulated Glass Units with Ring Shaped Pillars

(71) Applicant: Kyun Jang Chin, Oak Brook, IL (US)

(72) Inventor: Kyun Jang Chin, Oak Brook, IL (US)

(21) Appl. No.: 15/131,003

(22) Filed: Apr. 17, 2016

(51) Int. Cl. E06B 3/663; E06B 3/66; E06B 3/677; E06B 9/24

(52) U.S. Cl. CPC E06B 3/66304; E06B 3/677; E06B 9/24; E06B 3/6612; E06B 3/66309; E06B 2009/2417

(57) ABSTRACT

Vacuum insulated glass (VIG) units having ring shaped pillars. The VIG unit comprises two sheets of glass, an edge spacer and multilayer sealants for hermetic sealing of peripheral edge with a high vacuum gap between two sheets of glass. A plurality of pillars is located between two sheets of glass to support vacuum compressive pressure. The ring shaped pillar is made of transparent engineering plastic or glass and can support a compressive strength of 400 MPa or more.

### BACKGROUND OF THE INVENTIONS

Vacuum IG units are known in the art. There are good examples of VIG units in U.S. Pat. No. 20150079313; U.S. Pat. Nos. 5,664,395; 5,902,652 and etc.

The compressive strength of pillars, 400 MPa in the No. 20150079313 is adapted in this invention with other references.

In the most case of conventional VIG units, two sheets of glass are jointed by high heat melting fit glass and use of small supporting pillars, with diameters of 0.1 mm to 0.2 mm (U.S. Pat. No. 5,664,395). The conventional vacuum requires so many pillars that the heat conductivity of pillars is quite large and the more important factor is that speed of conductivity is very fast because of short height of pillars and peripheral edge of frit glass solder closure. And the conventional vacuum process requires making a hole on the glass sheet to install a pump-out tube.

These are high cost factors for making vacuum insulated glass and difficulties can arise for quality control with less R-value.

Without breakthrough these problems of making vacuum insulated glass(VIG) units cannot be manufactured at affordable price. In this invention rings (10) are used as pillar to provide high vacuum gap between two sheets of glass. And to match the high pillar rings (10), an edge spacer (30) is the same height throughout the design, which provide wide space to allow the pump-out tube (40) to be easily inserted through edge spacer (30).

The high vacuum gap increases R-value at exponential rate in certain range.

Also, this invention does not need to apply high heat soldering to joint two sheets of glass (51, 52) so as to keep low-E tempered glass safe.

Glass is now used frequently as curtain walls as well as for building glazing. This vacuum insulated glass system is a real advantage in construction. Replacing heavy concrete and/or blocks with the vacuum insulated glass, wall construction materials and structural materials can be saved also it gives wider choices for design. The duration of construction can be shortened too. Affordable price supply of VIG units can save energy and provide soundproof room which will enhance the quality of life.

In current VIG unit, peripheral edge of two sheets of glass is enclosed by soldered frit glass.

Instead I applied principle that vacuum compressive force against two sheet of glass is about 100 kN each sheet of glass which shall hold rings (10), edge spacer (30) and sealants (31,32) extremely hermetical tight and this is the kernel concept of this invention.

This invention will now be describe [symbol] companying illustrations.

### SUMMARY OF THE INVENTION

According to this invention, rings (10) are used as supporting pillars.

In this embodiment of VIG unit, the height of vacuum gap between two sheets of glass (51. 52) is 6 mm to 8 mm and number of 11 rings (10) are disposed between two sheets of glass in this example of 150 cm by 130 cm (see FIG. 9).

The wide gap made by high edge spacer (30) through which a pump-out tube (40) of 6 mm or less diameter which is proper size to connect vacuum pump and easy hermetic sealing after the vacuum processes can be inserted.

Large vacuum space made by high pillars (10) and the edge spacer (30) increase the R-value given degree of the vacuum.

So this invention does not always require high degree of vacuum. 10 Torr or 1 Torr is quite good to keep lower than 0.2 W/m²K.

But lower than 10⁻² to 10⁻³ Torr where heat conductivity drastically drops is preferable in actual work.

Also, the small number of rings (10) reduce conductivity rate of the pillars itself in VIG unit. The most important factor is that the fewer number of pillars (10) the better process for manufacturing.

This invention does not apply high heat to solder to joint two sheets of glass (51, 52).

Another advantage of this invention is that drilled holes are not required on the glass to deposit a pump-out tube.

Two sheets of glass (51,52) are enclosed by edge spacer (30) and therebetween to be sealed by multilayer sealants (31, 32) for a permanent hermetic seal. Each layer of the sealants has its own different characteristics which complement each other.

The edge spacer (30) is rolled formed D-shaped Metal (FIG. 8) can be sealed by butyl based nano vacuum silica contained sealant (30b). In addition, polysulfide base nano vacuum silica contained sealant (31) and nano vacuum silica contained silicon sealant (32) can be deposited in order. Then a natural lacquered cloths (33) closes sealant (32), and cover outside of two sheets of glass together (FIG. 4, FIG. 5). The peripheral edge may be covered by U-shaped metal channel or by carbon in case VIG units to be used as curtain wall.

### BRIEF DESCRIPTIONS OF THE DRAWINGS

FIG. 1 is an exploded perspective view of a VIG unit;

FIG. 2 is a top elevation partial cross-sectional view of the vacuum IG unit;

FIG. 3 is a sectional view of two sh [symbol] ss face to face shows etched surface (80) at the edge of the peripheral end of glass and groove (52a) therein adhesive thermal plastic film (11b) is layered in lower glass (52) to hold the rings (10), and low-E film (51a) is layered on upper glass;

FIG. 4 is a cross-sectional view, I-I, of the vacuum IG unit shows an edge spacer (30) and multilayer sealants (31, 32). Low-E film (51a) is layered on upper glass. Getter/desicaant (60) deposited inside of edge spacer (30) and open hole which communicate into vacuum space (100);

FIG. 5 is a cross-sectional view, II-II, therein a pump-out tube (40) is inserted through out edge spacer (30);

FIG. 6 is a perspective view of a supporting pillar ring (10) that is cut out (11a) at one end;

FIG. 7 is a cross sectional view, III-III, of the ring (10).

FIG. 8 is a perspective view of a piece of rolled formed D-shaped metal which consists metal edge spacer (30);

FIG. 9 shows the method of an equilibrium array of positions of rings (10) by using regular hexagons of which side lines are shared by all neighbor regular hexagons that are circumscribed inside the edge spacer (30);

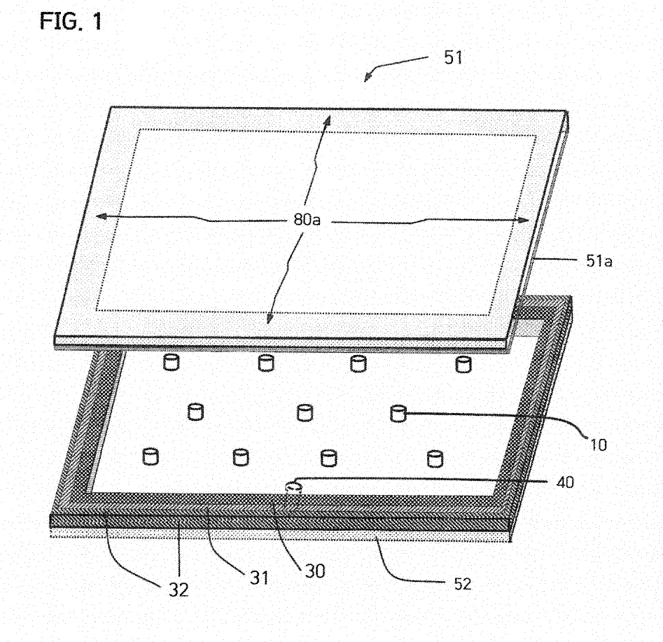

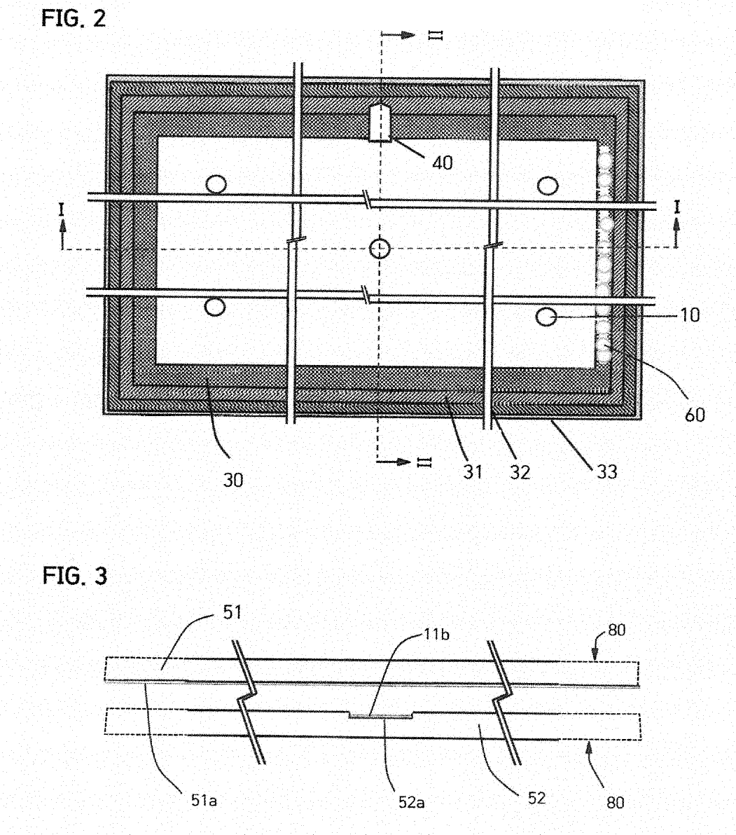

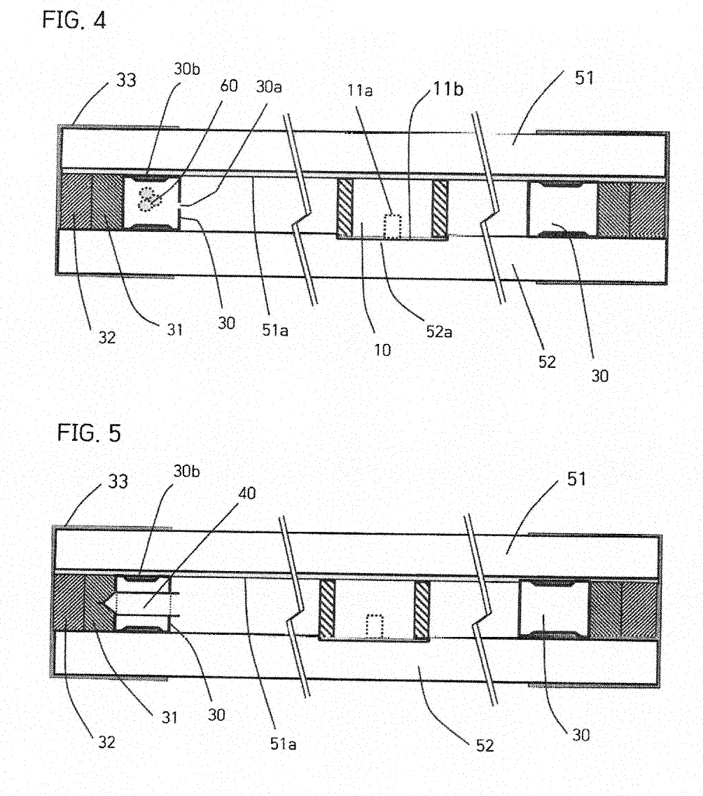

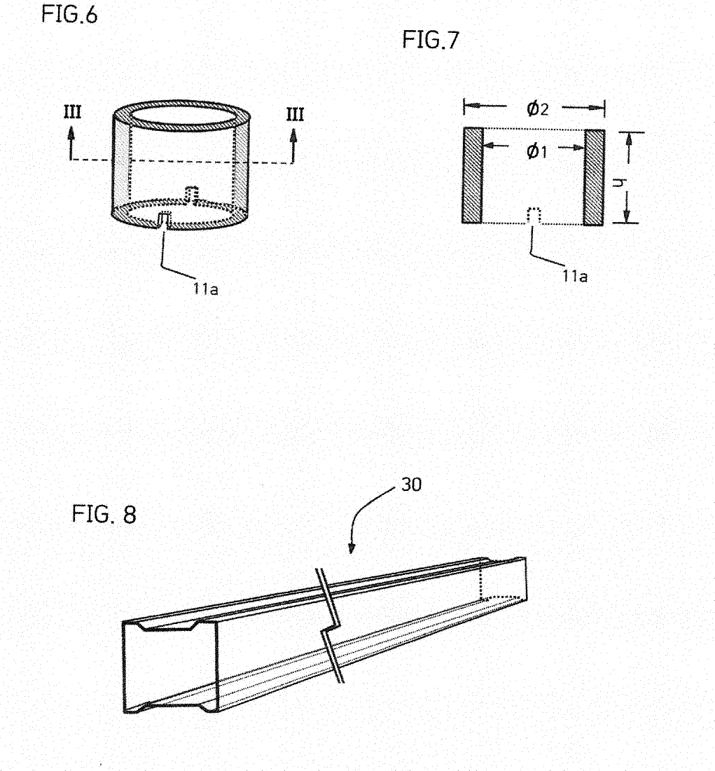

A cross point (9) of two orthogonal lines of the edge spacer (30) is the first position of a ring (10). This point (9) is the center of the drawing for the first regular hexagon and all other centers of regular hexagons and all vertexes end point of regular hexagons are the positions of rings (10).

### DETAILED DESCRIPTION

### Ring (FIG. 7)

Referring FIG. 7, rings (10) are as followings;

The ring (10) is formed from engineering plastic or glass casted and tempered whose specifications are such that height, h=6 mm to 8 mm; outside diameter, φ₂=14 mm to 16 mm; inside diameter, φ₁=12 mm to 14 mm; and the ring (10) is cut-out (11a) at the end through which adhesive material can be injected if necessary and communicate into vacuum space (100) which provide equal vacuum degree of vacuum space (100) that will hold ring tight with vacuum pressure and reduce heat conductivity.

At a point of position of rings (10) a sheet of two sheets of glass (52) may be grooved to the depth, d=0.4 mm to 0.8 mm and diameter is preferably slight larger than ring to accept ring (10) securely.

Before the ring (10) to be disposed on the glass, thermal plastic film (11b) is layered in the groove (52a) on lower sheet of glass (52) as adhesive which absorb shock and are adaptive to thermal [symbol] rinkage, too.

11 rings are disposed in this example size or 150 cm by 130 cm.

A compressive resist strength of the rings (10) is equal to or greater than 400 MPa

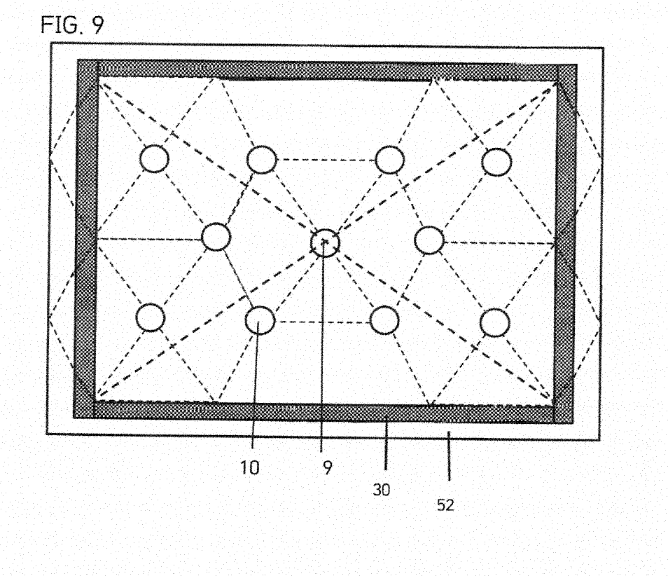

### Array of Rings (FIG. 9)

According to this invention, so as to be uniformly distributed of compressive stress from pairing two sheets of glass to rings (10), an array of position of rings (10) to be as follows:

Referring to FIG. 9 draw diagonal lines from the angle of a rectangular edge spacer (30) and it will cross at the center (9) of the edge spacer (30), then it is the farthest point from all the sides and corners of the rectangular edge spacer (30) so it is the most tensile stress weak point even all the compressive stress is equal throughout glass (Pascal's principle). And it could be the ideal position of the ring (10) if only a ring (10) is to be disposed.

This is the center (9) to draw regular hexagon and the same size regular hexagons fill the inside of the rectangular edge spacer (30) such that all the hexagons share all side lines with the adjacent hexagons and disposed rings (10) on the center of the hexagon and all the vertex points of hexagons. Then all the distances to the nearest adjacent positions of rings (10) are equal so that all the rings uniformly share the tensile stress of vacuum pressure. Let's disregard very little deviation from near the edge spacer (30) to center (9) of the glass by making center ring (10) which is the most stressed is made as standard for all the rings (10).

### Edge Spacer (FIG. 8)

Referring to FIG. 8, the edge spacer (30) is roll formed D-shaped metal (30) which one of sides has holes (30a) toward inside therein getters/desiccants (60) are filled and thermal plastic film maybe laminated on metal or thermal plastic spacer.

The edge spacer (30) in case of metal comprises of 4 pieces of roll formed channel (FIG. 8) which are inserted into plastic angle connector at corner of rectangular.

To adjust difference of heat expansion/shrinkage between glass and metal, the end of channel is kept 0.6 mm to 1.4 mm apart from full inserted.

Specifications of the edge spacer is such that equal to (W−(30±4) mm)×(L−30±4 mm), where W is width and L is length of glass and height is the same as the ring (10).

### Processes of Vacuum

According to this invention, a pump-out tube (40), 3 mm to 6 mm diameter is inserted through out edge spacer (30) inside out at the center of a side preferably in the longer side before edge spacer (30) to be disposed on the sheet of glass (52).

The said diameter is good size nether small nor large to connect vacuum hose and for cut and seal. With very small diameter of tube (40), it is very difficult to work with at current VIG. After evacuating through a pump-out tube to be cut and sealed by pressive heat iron. And immediately the cut tube to be buried in the sealant layer (31).

The compressive pressure of vacuum of 10⁻³ Torr to 10⁻⁴ Torr hold two sheets of glass tight all together therebetween edge spacer (30) is disposed and multilayer sealants (31,32) are deposited hermetically.

Vacuum compressive force against two sheet of glass is about 200 kN which hold rings (10), edge spacer (30) and sealants (31,32) tight

### Multilayer Sealings

Two sheets of glass (51. 52) and edge spacer/sealants (30, 31, 32) and lacquer cloths (33) encloses the vacuum space (100). The suction power of vacuum is so strong that hold all together tight with seals.

According to this invention materials of multilayer sealants (31,32) compose of vacuum nano silica that enhance hermetical sealing and stabilize materials.

According to this invention the edge spacer (30) between apart two sheets of glass (51, 52) is sealed by butyl based sealant which contains nano vacuum silicon. Then polysulfide based vacuum nano silica sealant is to be sealed (31) and vacuum nano silica contained silicon sealant (32).

Then natural lacquer cloths (33) close sealant (32) and covers peripheral edge of two sheet of glass. Then U-shaped carbon or metal covers alongside lacquer cloths (33) in case of curtain wall that would contribute further sealing and protect sealants and edge of sheets of glass.

The peripheral edge of sheets of glass may be etched (80) for better adhesive and seals.

One of two sealings may be omitted if lacquer cloths (33) closes sealant and cover peripheral edge of two sheets of glass.

Embodiments of this Invention are optimum solutions based on 3 mm to 6 thermal plastic film is layered in the groove where ring to be disposed. mm thick glass so if the glass thickness is different, the parts and dimensions can be easily adjusted.

And low-E tempered glass is recommended for at least one (51) of the two sheets of glass.

1. A vacuum insulated glass unit having ring shaped pillars, comprising: two spaced apart sheets of glass; an edge spacer and multilayer seals between two sheets of glass with a vacuum gap between two sheets of glass; and a plurality of rings between two sheets of glass, the rings comprising: a body; cut-outs at one end; of which inside diameter, φ₁=12 mm to 14 mm; outside diameter, φ₂=14 mm to 16 mm; and height, h=6 mm to 8 mm:
and the compressive strength of the pillars is equal to or greater than 400 MPa.

2. The vacuum insulated glass unit of claim 1, wherein one of two sheets of glass is grooved to depth between 0.4 mm and 0.8 mm with slight larger outside diameter of the ring to hold the ring.

3. The vacuum insulated glass unit of claim 2, wherein the thermal plastic film is layered in the groove where the ring to be disposed as adhesive which absorb shock and adaptive to thermal expansion/shrink.

4. The vacuum insulated glass unit of claim 1, one of two sheets of glass may be tempered and low-E film is layered.

5. The vacuum insulated glass unit of claim 1, wherein the said ring is glass casted and tempered or transparent engineering plastic injected.

6. The vacuum insulated glass unit of claim 1, wherein the first ring is positioned at a point where the diagonal lines of the rectangular edge spacers crossed.

7. The vacuum insulated glass unit of claim 6, wherein the said crossed point is the center to draw a regular hexagon and all the rings to be disposed at centers of hexagons and vertexes which share all side lines with other regular hexagons which is circumscribed by the edge spacer.

8. The vacuum insulated glass unit of claim 7, the said points are equal distances each other where rings to be disposed. This is the center (9) to draw regular hexagon and the same size regular hexagons fill the inside of the rectangular edge spacer (30) such that all the hexagons share all side lines with the adjacent hexagons and disposed rings (10) on the center of the hexagon and all the vertex points of hexagons.

9. The vacuum insulated glass unit of claim 8, wherein the distance between rings is from 150 mm to 320 mm.

10. The vacuum insulated glass unit of claim 1, wherein the edge spacer has a distance, d=20±4 mm from end lines of glass.

11. The vacuum insulated glass unit of claim 9, wherein the edge spacer is sealed between two sheets of glass by butyl based vacuum nano silica contained sealant.

12. The vacuum insulated glass unit of claim 11, wherein the pump-out tube is inserted throughout the edge spacer which will communicate between vacuum space and exterior.

13. The vacuum insulated glass unit of claim 12, wherein further layer of sealant comprises polysulfide based sealant containing vacuum nano silica.

14. The vacuum insulated glass unit of claim 9, wherein further layer of sealant comprises a silicon sealant containing vacuum nano silica.

15. The vacuum insulated glass unit of claim 1, wherein the vacuum space enclosed between two sheets of glass, an edge spacer and multilayer sealants is evacuated.

16. The vacuum insulated glass unit of claim 1, wherein the outside edge of two sheets of glass is sealed and covered by natural lacquer cloths.

17. The vacuum insulated glass unit of claim 1, wherein the edge of two sheets of glass are etched inside of sealing area and outside area where lacquer cloths covers.
